(19) United States
(12) Patent Application Publication
(10) Pub. No.: US 2006/0264188 A1
(43) Pub. Date: Nov. 23, 2006

(54) Power supply for a communications module that demands high power during predetermined periods

(76) Inventors: Pierre Mars, Lane Cove (AU); George Lange Paul, Chatswood West (AU)

Correspondence Address: KENYON & KENYON LLP, 1500 K STREET N.W., SUITE 700, WASHINGTON, DC, 20005, US

(21) Appl. No.: 10/525,216

(22) PCT Filed: Aug. 29, 2003
(86) PCT No.: PCT/JP03/01117

§ 371 Date: Jul. 26, 2005

Related U.S. Application Data
(63) Continuation-in-part of application No. PCT/AU03/01117, filed on Aug. 29, 2003.

(51) Int. Cl. H04B 1/04

(52) U.S. Cl. 455/127.1

(57) ABSTRACT

A power supply (1) is provided for a communications module, in the form of a cellular telephone GPRS module (2). This module demands high power during predetermined periods. Supply (1) includes a battery module (3) for providing module (2) with a supply voltage that, in this embodiment, is about 3.6 Volts. During the predetermined periods, module (3) provides a first current at a first voltage that is less than the supply voltage. A supercapacitive device, in the form of a single supercapacitor (4), is connected in parallel with module (3) for providing module (2) with, a second current during the predetermined periods such that first voltage is maintained above about 90% of the supply voltage. That is, the first voltage is maintained above about 3.24 Volts.

### FIELD OF THE INVENTION

The present invention relates to a power supply and in particular to a power supply for a communications module that demands high power during predetermined periods.

The invention has been developed primarily for use with a GPRS communications module for a cellular telephone and will be described hereinafter with reference to that application. It will be appreciated; however, that the invention is not limited to that particular field of use and is also suitable for other pulsed power loads including by way of example, communications modules such as a GSM module, a Mobitex module, a PCMCIA card, a Compact Flash card, a communications card or device for a notebook computer, a laptop computer or a Tablet computer, or a wireless LAN device—such as a desktop or other computer—or other wireless devices.

### BACKGROUND

Known mobile communications modules, such as GPRS modules, are used in cellular telecommunication handsets. The modules include a number of integrated circuits that collectively function to allow information to be processed and transmitted in accordance with the required communications standard. In the case of GPRS telephone handsets the information is usually voice data, although non-voice data is transmitted similarly. For other applications, such as a dedicated communication card in a laptop computer, the information is usually other than voice data.

The circuitry typically included within a GPRS module is a digital signal processor that is responsive to the data that is to be transmitted for providing a modulation signal, an RF oscillator for providing a carrier signal, and a mixer for combining the carrier signal and the modulation signal to form a transmission signal This latter signal if provided to an RE power amplifier that drives an antenna to wirelessly transmit the signal to a base station.

The communications module is provided with power from a battery module that generally includes a lithium ion or Lithium Polymer battery or a number of such batteries in parallel. The battery notionally provides a zero current voltage of about 3.6 V to the communications module, although this varies between about 4.2 V to 3.0 V over the discharge cycle. In some instances, the battery module includes protection circuitry for limiting tae current provided by the battery. In any event, the battery module includes a finite output impedance and, therefore, the supply of power to the communications module will be at a voltage less than the zero current voltage.

The communications standard for GPRS signals results in the communication module having two distinct power consumption modest these being a standby or a low power mode—where transmission or reception of data is not occurring—and a high power mode—where transmission or reception of data is occurring. During the high power mode, the power consumption of the module is concentrated in pulses, the timing and duration of which are set out in the standard. For GPRS Class 10, the pulses are of 1.15 msec duration, and are separated by 3.45 msec gaps.

In the high power mode, the increased power consumption arises predominantly because of the RF power amplifier being active to drive the antenna or to amplify the signal received by the antenna. Typically, during transmission, the communications module draws about 1 to 2 Amps from the battery module to allow 16 the antenna to be driven at about 2 Watts. However, as the power amp is typically has an efficiency of about 40% to 60%, it draws about 3.3 to 5 Watts Typically, during reception, the communications module draws about 0.1 to 0.3 Amps from the battery module.

The design constraints for communication devices, and particularly for mobile communications devices such as cellular telephone handsets, is strongly driven to minimise the handset size while maximizing the period between recharging of the battery. This suggests that the battery should have as high an energy density as possible. However, batteries of this type typically have a high time constant and are therefore compromised in their ability to provide the required voltage and current during the high power mode of the device and in particular during the pulses. Accordingly, the more usual compromise is to tolerate a lower power density but gain a shorter time constant.

In partial answer to this problem, it has been known to use a bank of parallel tantalum capacitors to assist the battery during the high power mode. While some small advantage is gained, this is usually not justified by the cost and bulk of these capacitors.

The design of wireless communication devices for wireless LANs, PCMCIA cards and the like, is driven to achieve the desired functionality while also minimising volume, peak power consumption and cost. The demands for increased functionality and wider bandwidth communication places an increased premium on PCB “real estate” and packaging volumes.

Any discussion of the prior art throughout the specification should in no way be considered as an admission that such prior art is widely know or forms part of common general knowledge in the field.

### SUMMARY OF THE INVENTION

It is an object of the present invention to overcome or ameliorate at least one of the disadvantages of the prior art, or to provide a useful alternative.

According to a first aspect of the invention there is provided a power supply for a communications module that demands high power during predetermined periods, the power supply including:

a battery module for providing the communications module with a supply voltage wherein, dung the predetermined periods, the battery module provides a first current at a first voltage that is less than the supply voltage; and

a supercapacitive device in parallel with the battery module for providing the communications module with a second current during the predetermined periods such that first voltage is maintained above about 90% of the supply voltage.

In some embodiments the power supply also provides power to circuitry other than the communications module.

According to a second aspect of the invention there is provided a power supply for a communications module that demands high power during predetermined periods, the power supply including:

a battery module for providing the communications module with a supply voltage wherein, during the predetermined periods, the battery module provides a first current at a first voltage that is less than the supply voltage; and

a supercapacitive device in parallel with the battery module for providing the communications module with a second current such that variation in the first voltage dating the predetermined periods is less than about 5% of the supply voltage.

Preferably, the first voltage is maintained above about 92% of the supply voltage. Even more preferably, the first voltage is maintained above about 95% of the supply voltage.

Preferably also, the battery module includes a lithium ion battery and the notional supply voltage is about 3.6 V.

In a preferred form, the supercapacitive device is a single supercapacitor. More preferably, the supercapacitor has a capacitance of about 380 mF and an ESR of less than about 100 mΩ. Even more preferably, the supercapacitor includes two supercapacitive cells connected in series, a package for containing the cells, and two terminals being connected to the respective cells and extending from the package.

Preferably, the communications module includes:

a processor being responsive to data for generating a first signal;

an RF oscillator for providing a cattier signal;

a mixer for modulating the carrier signal with the first signal to generate a transmission signal; and

a power amplifier being responsive to the transmission signal for driving a wireless transmitter during the predetermined periods to transmit the transmission signal.

Preferably also, the communications module is a GPRS module. In other embodiments, the communications module is a CSM or Mobitex module.

In a preferred form, the communications module is a mobile telecommunications module. More preferably, the communications module is a GPRS module or a GSM module. In other embodiments, however, the communications module is part of one of the following devices: a PCMCIA card; a Compact Flash card; a notebook computer; a laptop computer; a Tablet computer; or a wireless LAN device.

Preferably, the power demanded by the communications module in the predetermined period includes periodic pulses of high power demand separated by substantially uniform intermediate power demand. More preferably, the intermediate demand endures for about three times the duration of the high power demand.

According to a third aspect of the invention there is provided a power supply for a communications module that demands high power during predetermined periods, the power supply including:

a battery module for providing the communications module with a supply voltage wherein, during the predetermined periods, the battery module provides a first current at a first voltage that is less than the supply voltage; and

a supercapacitive device in parallel with the battery module for providing the communications module with a second current during the predetermined periods such that the difference between the first voltage and the supply voltage is less than about 300 mV.

According to a fourth aspect of the invention there is provided a power supply for a communications module that demands high power during predetermined periods, the power supply including:

a battery module for providing the communications module with a supply voltage wherein, dung the predetermined periods, the battery module provides a first current at a first voltage that is less than the supply voltage; and

a supercapacitive device in parallel with the battery module for providing the communications module with a second currant such that variation in the first voltage during the predetermined periods is less than about 200 mV.

Preferably, the battery module includes a lithium ion battery or a Lithium polymer battery and the supply voltage is about 3.6 V. More preferably, the difference between the first voltage and the supply voltage is less than about 250 mV.

In a preferred form, the battery module includes:

a rechargeable battery for providing a battery voltage;

two terminals across which the supply voltage is provided; and

protection circuitry disposed between the battery and the terminals for limiting the current drawn from the battery.

In other embodiments, the battery module comprises a battery.

Preferably, the communications module includes:

a processor being responsive to data for generating a first signal;

an RF oscillator for providing a carrier signal;

a mixer for modulating the carrier signal with the first signal to generate a transmission signal; and

a power amplifier being responsive to the transmission signal for driving a wireless transmitter during the predetermined periods to transmit the transmission signal.

Preferably also, the communications module is a GPRS module. In other embodiments, the communications module is a Mobitex module or a 3G module.

Preferably, the circuitry limits the peak current drawn from the battery. More preferably, the circuitry also limits the average current drawn from the battery during the predetermined periods.

Preferably also, the battery module has a predetermined output impedance and the supercapacitive device includes a predetermined ESR that is less than the output impedance. In embodiments where the battery module consists of the battery, the output impedance equates to the sum of the internal resistance of the battery.

In a preferred form, the volume of the supercapacitive-device is less about 2.7 cc. More preferably, the supercapacitive device is a single supercapacitor having a packaged volume of less than 1.5 cc.

According to a fifth aspect of the invention there is provided a power supply for a communications module that demands high power during predetermined periods, the power supply including:

a battery module for providing the communications module with a supply voltage Vₛᵥ wherein, during the predetermined periods, the battery modules provides a first current i_{b} at a first voltage vₛ that is less than Vₛᵥ; and

a supercapacitive device having a predetermined equivalent series resistance R_{S} and being in parallel with the battery module, the supercapacitor providing the communications module with a second current is during the predetermined periods such that, throughout those periods, (Vₛᵥ−vₛ)≦R_{S}·(i_{b}+iₛ).

Preferably, the battery module consists of a battery. More preferably, the battery is a lithium ion battery and Vₛᵥ is about 3.6 V. Even more preferably, (Vₛᵥ−vₛ) is less than about 300 mV. However, in other embodiments, (Vₛᵥ−vₛ) is less than about 250 mV.

Preferably, the supercapacitive device includes a single supercapacitor having a plurality of supercapacitive cells. More preferably, the cells are connected in series. Even more preferably, the cells are contained within the same package. However, in other embodiments, the cells are contained within separate packages.

According to a sixth aspect of the invention there is provided a power supply for a communications module that demands high power during predetermined periods, the power supply including:

a battery module having an output impedance and providing the communications module with a supply voltage wherein, during the predetermined periods, the battery module provides a first current at a first voltage that is less than the supply voltage; and

a supercapacitive device in parallel with the battery module and having an equivalent series resistance that is less than the output impedance, the supercapacitive device providing the communications module with a second current dung the predetermined periods such that the first voltage is maintained at or above a predetermined threshold.

Preferably, the threshold is about 90% of the supply voltage. More preferably, the threshold is about 92% of the supply voltage. Even more preferably, the threshold is about 95% of the supply voltage.

Preferably also, the threshold is about 300 mV less than the supply voltage. More preferably, the threshold is about 250 mV less than the supply voltage. Even more preferably, the threshold is about 200 mV less than the supply voltage.

In a preferred form the battery module is comprised of a battery and the supercapacitive device is comprised of a supercapacitor. In other embodiments, however, the battery module includes a plurality of electrically connected batteries and the supercapacitive device includes a plurality of electrically connected supercapacitors.

Preferably, the battery module includes a battery, two teals between which the first voltage is provided, and protection circuitry disposed between the battery and the terminals for limiting the fist current. More preferably, the first current is limited to an instantaneous peak value. Even more preferably, the first current is limited to an average value during the predetermined periods.

According to a seventh aspect of the invention there is provided a power supply for a mobile GPRS communications module that alternates between a high power consumption mode and a low power consumption mode, the power supply including:

a battery module for providing the communications module with a supply voltage; and

a supercapacitor connected in parallel with the battery module, the supercapacitor having an equivalent series resistance of less than 100 mΩ, a capacitance of at least 300 mF and a volume of less than 2.7 cc.

According to an eighth aspect of the invention there is provided a power supply for a communications module that demands high power during predetermined periods, the power supply including:

a supply rail for providing the communications module with a supply voltage wherein, during the predetermined periods, the supply rail provides a first current at a first voltage that is less than or equal to the supply voltage; and

a supercapacitive device in parallel with the battery module for providing the communications module with a second current such that variation in the first voltage during the predetermined periods is less than about 5% of the supply voltage.

Preferably, the supply rail is connected to a battery module. However, in other embodiments, the supply rail is connected to a regulated power supply.

According to a ninth aspect of the invention there is provided a power supply for a communications module that demands high power during predetermined periods, the power supply including:

a supply rail for providing the communications module with a supply voltage wherein, during the predetermined periods, the supply rail provides a first current at a first voltage that is less than the supply voltage; and

a supercapacitive device in parallel with the supply rail for providing the communications module with a second current such that variation in the first voltage during the predetermined periods is less than about 200 mV.

More preferably, the variation in the fist voltage during the predetermined periods is less than about 150 mV.

According to a tenth aspect of the invention there is provided a power supply for simultaneously supplying power to a power amplifier circuit and an oscillator circuit that provides an output signal, wherein the circuits collectively demand high power during predetermined periods and, during those periods, the power amplifier circuit demands temporally spaced pulses of high power, the power supply including:

a supply rail for providing the circuits with a supply voltage wherein, during the predetermined periods, the supply rail provides a first current at a first voltage that is less than the supply voltage; and

a supercapacitive device in parallel with the supply rail for reducing the variation in the first voltage during the predetermined periods such that the variation in the output signal is reduced.

According to an eleventh aspect of the invention there is provided a wireless telecommunications device having a communications module that demands high power during predetermined periods, the telecommunications device including:

a battery module having an output impedance and providing the communications module with a supply voltage wherein, during the predetermined periods, the battery module provides a first current at a first voltage that is less than the supply voltage; and

a supercapacitive device in parallel with the battery module and having an equivalent series resistance that is less than the output impedance, the supercapacitive device providing the communications module with a second current during the predetermined periods such that the first voltage is maintained at or above a predetermined threshold.

According to a twelfth aspect of the invention there is provided a wireless telecommunications device having a communications module that demands high power during predetermined periods, the telecommunications device including:

a supply rail having an output impedance, the supply rail providing the communications module with a supply voltage wherein, during the predetermined periods the supply rail provides a first current at a first voltage that is less than the supply voltage; and

a supercapacitive device in parallel with the battery module and having an equivalent series resistance that is less than the output impedance, the supercapacitive device providing the communications module with a second current during the predetermined periods such that the flirt voltage is maintained at or above a predetermined threshold.

Preferably, the wireless telecommunications device is a handset for a cellular telephone. More preferably, the communications module is a GPRS module, a GSM module or a Mobitex module. In other embodiments, however, the telecommunications device is a PCMCIA card or a Compact Flash card; or a notebook computer, a laptop computer, a Tablet computer, or a wireless LAN device that includes such a card.

According to a thirteenth aspect of the invention there is provided a wireless telecommunications device having a communications module that demands high power during predetermined periods, the telecommunications device including:

a battery module for providing the communications module with a supply voltage Vₛᵥ wherein, during the predetermined periods, the battery modules provides a first current i_{b} at a first voltage vₛ that is less than Vₛᵥ; and

a supercapacitive device having a predetermined equivalent series resistance R_{S} and being in parallel with the battery module, the supercapacitor providing the communications module with a second current is during the predetermined periods such that, throughout, those periods, (Vₛᵥ−vₛ)≦R_{S}·(i_{b}+iₛ).

According to a fourteenth aspect of the invention there is provided a telecommunications system including:

at least one base station; and

a plurality of telecommunications modules of one or more of the eleventh, twelfth and thirteenth aspects, the telecommunications modules selectively communicating wirelessly with the base station.

According to a fifteenth aspect of the invention there is provided a card for a computing device including a power source for providing a source current up to a predetermined current limit, the card including:

a substrate;

an electrical load mounted to the substrate for drawing pulsed power from the power source, wherein the load demands a peak current greater than the predetermined current limit; and

a supercapacitive device mounted to the substrate and being connected in parallel with the load to ensure that the source current is contained below the predetermined current limit.

In an embodiment, the charge storage device is a supercapacitor. Preferably, the supercapacitor includes a footprint that is less than 700 mm². Even more preferably, the supercapacitor includes a plurality of terminals for allowing connection of the supercapacitor to external circuitry, wherein the terminals extend beyond the footprint.

In an embodiment, the supercapacitor includes a height “H” normal to the substrate of less than 2.3 mm.

In an embodiment, the ESR of the charge storage device is less than about 115 mΩ.

In an embodiment, the capacitance of the charge storage device is greater than 90 mF.

According to a sixteenth aspect of the invention there is provided a power supply for a load, the power supply including:

a voltage rail for providing a voltage to the load;

a supercapacitive device having a predetermined footprint and a predetermined ESR for connecting to the rail in parallel with the load, wherein the quotient of the predetermined footprint and the predetermined ESR is greater than about 4 mm²/mΩ.

In an embodiment, the quotient is greater than about 5 mm²/mΩ. In some embodiments, the quotient is greater than about 10 mm²/mΩ, while in others it is greater than 66 mm²/mΩ.

According to a seventeenth aspect of the invention there is provided a power supply for a load, the power supply including:

a voltage rail for providing a voltage to the load;

a supercapacitive device having a predetermined capacitance and a predetermined footprint for connecting to the rail in parallel with the load, wherein the quotient of the predetermined capacitance and the predetermined footprint is greater than about 0.15 mF/mm².

In an embodiment, the quotient is greater than about 0.5 mF/mm². In some embodiments, the quotient is greater than about 1 mF/mm².

According to an eighteenth aspect of the invention there is provided a power supply for a load, the power supply including:

a voltage rail for providing a voltage to the load;

a supercapacitive device having a predetermined volume and a predetermined ESR for connecting to the rail in parallel with the load, wherein the quotient of the predetermined volume and the predetermined ESR is greater than about 6 mm³/mΩ.

In an embodiment, the quotient is greater than about 20 mm³/mΩ. In other embodiments, the quotient is greater than about 100 mm³/mΩ,

In an embodiment, the supercapacitor has a height that is less than 2.3 mm.

According to a nineteenth aspect of the invention there is provided a power supply for a load, the power supply including:

a voltage rail for providing a voltage to the load;

a supercapacitive device hazing a predetermined capacitance and a predetermined volume for connecting to the rail in parallel with the load, wherein the quotient of the predetermined capacitance and the predetermined volume is greater than about 0.09 mF/mm³.

In an embodiment, the quotient is greater than about 0.5 mF/mm³ In other embodiments, the quotient is greater than about 2 mF/mm³.

In an embodiment, the supercapacitor has a height that is less than 2.3 mm.

According to a twentieth aspect of the invention there is provided a power supply for a load, the power supply including:

a voltage rail for providing a voltage to the load;

a supercapacitive device having a predetermined time constant and a predetermined footprint for connecting to the rail in parallel with the load, wherein the quotient of the predetermined time constant and the predetermined footprint is greater than about 15 μsec/mm².

In an embodiment, the quotient is greater than 40 μsec/mm². In other embodiments, the quotient is greater than about 120 μsec/mm².

According to a twenty first aspect of the invention there is provided an interface for connecting a power supply that provides a supply current having a predetermined current limit to a load that draws a load current, the interface including:

input terminals connected to the power supply,

output terminals connected to the load, and

a supercapacitive device connected in parallel with the input terminals or the output terminals for allowing the load current to temporarily exceed the predetermined current limit while maintaining the supply current at less than the predetermined current limit.

According to a twenty second aspect of the invention there is provided a power supply including:

a supply rail that provides a supply current of up to a predetermined current limit to a load that draws a load current; and

a supercapacitive device connected in parallel with the supply rail or the load for allowing the load current to temporarily exceed the predetermined current limit while maintaining the supply current at less than the predetermined current limit.

In an embodiment, the supercapacitive device has an effective capacitance of at least 10% for a 0.03 msec pulse. Preferably, the supercapacitive device has an effective capacitance of at least 35% for a 1 msec pulse. More preferably, the supercapacitive device has an effective capacitance of at least 55% for a 10 msec pulse.

According to a twenty third aspect of the invention there is provided a supercapacitive device including:

at least two opposed and spaced apart electrodes;

a package for containing the electrodes and an electrolyte and which has a predetermined footprint;

at least two terminals extending from the package for allowing external electrical connection with the electrodes, wherein the device has a predetermined ESR and the quotient of the predetermined footprint and the predetermined ESR is greater than about 4 mm²/mΩ.

In an embodiment, the quotient is greater than about 5 mm²/mΩ. In some embodiments, the quotient is greater than about 10 mm²/mΩ, while in others it is greater than 66 mm²/mΩ.

In an embodiment, the supercapacitive device has an effective capacitance of at least 100% for a 0.03 msec pulse. Preferably, the supercapacitive device has an effective capacitance of at least 35% for a 1 msec pulse. More preferably, the supercapacitive device has an effective capacitance of at least 55% for a 10 msec pulse.

According to a twenty fourth aspect of the invention there is provided a supercapacitive device including:

at least two opposed and spaced apart electrodes;

a package for containing the electrodes and an electrolyte and which has a predetermined footprint;

at least two terminals extending from the package for allowing external electrical connection with the electrodes, wherein the device has a predetermined capacitance and the quotient of the predetermined capacitance and the predetermined footprint is greater than about 0.15 mF/mm².

In an embodiment, the quotient is greater than about 0.5 mF/mm². In some embodiments, the quotient is greater than about 1 mF/mm².

In an embodiment, the supercapacitive device has an effective capacitance of at least 10% for a 0.03 msec pulse. Preferably, the supercapacitive device has an effective capacitance of at least 35% for a 1 msec pulse. More preferably, the supercapacitive device has an effective capacitance of at least 55% for a 10 msec pulse.

According to twenty fifth aspect of the invention there is provided a supercapacitive device including:

at least two opposed and spaced apart electrodes;

a package for containing the electrodes and an electrolyte and which has a predetermined volume;

at least two terminals extending from the package for allowing external electrical connection with the electrodes, wherein the device has a predetermined ESR and the quotient of the predetermined volume and the predetermined ESR is greater than about 6 mm³/mΩ.

In an embodiment, the quotient is greater than about 20 mm³/mΩ. In other embodiments, the quotient is greater than about 100 mm³/mΩ.

In an embodiment, the supercapacitor has a height that is less than 2.3 mm.

In an embodiment, the supercapacitive device has an effective capacitance of at least 10% for a 0.03 msec pulse. Preferably, the supercapacitive device has an effective capacitance of at least 35% for a 1 msec pulse. More preferably, the supercapacitive device has an effective capacitance of at least 55% for a 10 msec pulse.

According to a twenty sixth aspect of the invention there is provided a supercapacitive device including:

at least two opposed and spaced apart electrodes;

a package for containing the electrodes and an electrolyte and which has a predetermined volume;

at least two terminals extending from the package for allowing external electrical connection with the electrodes, wherein the device has a predetermined capacitance and the quotient of the predetermined capacitance and the predetermined volume is greater than about 0.09 mF/mm³.

In an embodiment, the quotient is greater than about 0.5 mF/mm³. In other embodiments, the quotient is greater than about 2 mF/mm³;

In an embodiment, the supercapacitor has a height that is less than 2.3 mm.

In an embodiment the supercapacitive device has an effective capacitance of at least 10% for a 0.03 msec pulse. Preferably, the supercapacitive device has an effective capacitance of at least 35% for a 1 msec pulse. More preferably, the supercapacitive device has an effective capacitance of at least 55% for a 10 msec pulse.

According to a twenty seventh aspect of the invention there, is provided a supercapacitive device including:

at least two opposed and spaced apart electrodes;

a package for containing the electrodes and an electrolyte and which has a predetermined footprint;

at least two terminals extending from the package for allowing external electrical connection with the electrodes, wherein the device has a predetermined time constant and the quotient of the predetermined time constant and the predetermined footprint is greater than about 15 μsec/mm².

In an embodiment, the quotient is greater than 40 μsec/mm². In other embodiments, the quotient is greater than about 120 μsec/mm².

In an embodiment, the supercapacitive device has an effective capacitance of at least 10% for a 0.03 msec pulse. Preferably, the supercapacitive device has an effective capacitance of at least 35% for a 1 msec pulse. More preferably, the supercapacitive device bas an effective capacitance of at least 55% for a 10 msec pulse.

According to a twenty eighth aspect of the invention there is provided a supercapacitive device including:

at least two opposed and spaced apart electrodes;

a package for containing the electrodes and an electrolyte, at least two terminals extending from the package for allowing external electrical connection with the electrodes, wherein the effective capacitance provided by the device the device has a predetermined time constant and the quotient of the predetermined time constant and the predetermined footprint is greater than about 15 μsec/mm².

In an embodiment, the supercapacitive device has an effective capacitance of at least 10% for a 0.03 msec pulse. Preferably, the supercapacitive device has an effective capacitance of at least 35% for a 1 msec pulse. More preferably, the supercapacitive device has an effective capacitance of at least 55% for a 10 msec pulse.

Unless the context clearly requires otherwise, throughout the description and the claims, the words ‘comprise’, ‘comprising’, ‘include’, ‘including’, and the like are to be construed in an inclusive sense as opposed to an exclusive or exhaustive sense; that is to say, in the sense of “including, but not limited to”.

### BRIEF DESCRIPTION OF THE DRAWINGS

Embodiments of the invention will now be described, by way of example only and not by way of limitation, in the accompanying drawings in which like references indicate similar elements. It should be noted that references to “an” or “one” embodiment in this disclosure are not necessarily to the same embodiment, and such references mean at least one. In the accompanying drawings:

FIG. 1 is a schematic illustration of a cellular telephone handset containing a power supply according to the invention;

FIG. 2 is an enlarged schematic illustration of the power supply of FIG. 1;

FIG. 3 is a trace of the voltage and current waveforms for a battery module that is supplying a GPRS module that is operating in the high power consumption mode;

FIG. 4 is a race of the corresponding voltage and current waveforms for the battery module of FIG. 3 when in parallel with eight 470 F tantalum capacitors;

FIG. 5 is a trace of the corresponding voltage and current waveforms for the battery module of FIG. 3 when in parallel with a single 380 mF supercapacitor having an BSR of 70 mΩ;

FIG. 6 is a phase diagram for an 8PSK modulation schema;

FIG. 7 is a schematic illustration of a power supply according to another embodiment of the invention;

FIG. 8 is a top view of a single cell supercapacitor that is suitable for use in a power supply of the invention;

FIG. 9 is a top view of a multi-cell supercapacitor that is suitable for use in a power supply of the invention;

FIG. 10 is a plot for a plurality of supercapacitors used in embodiments of the invention, the plot being of the capacitance and the reciprocal of the ESR for those supercapacitors when both are normalised for footprint;

FIG. 11 is a plot for a plurality of supercapacitors used in embodiments of the invention, the plot being of the capacitance and the reciprocal of the ESR for those supercapacitors when both are normalised for packing volume;

FIG. 12 is a plot similar to FIG. 11, although only for supercapacitors with a height of less than 2.3 mm;

FIG. 13 is a plot for a plurality of supercapacitors used in embodiments of the invention, the plot being of the RC time constant for those supercapacitors when normalised for footprint; and

FIG. 14 is a plot of the effective capacitance provided by a supercapacitive device for a range of pulse widths to which that device is exposed.

### DETAILED DESCRIPTION OF THE EMBODIMENTS

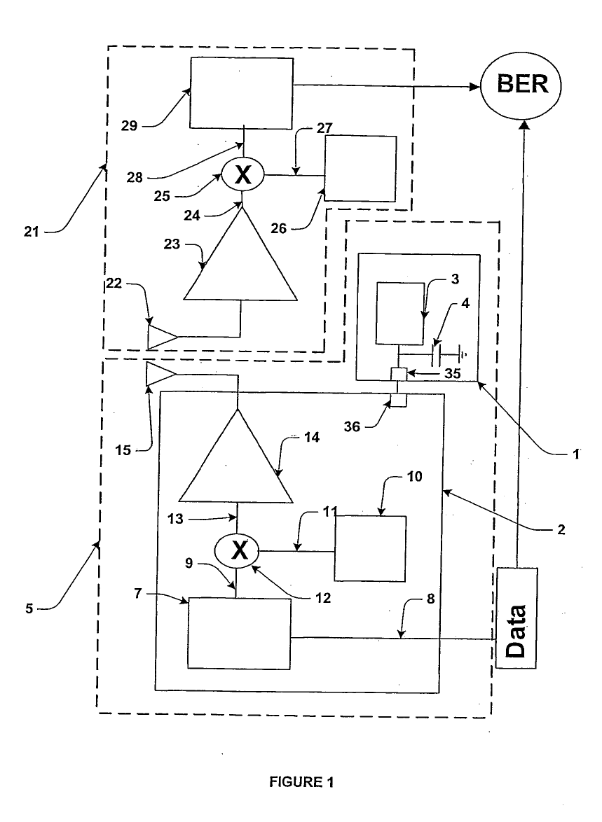

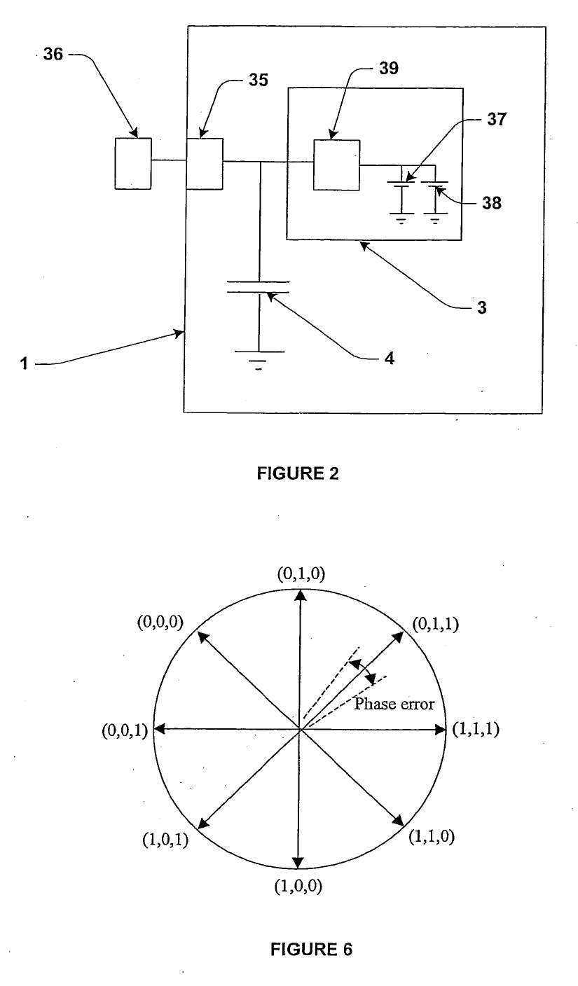

Referring to FIG. 1, there is schematically illustrated a power supply 1 for a communications module, in the form of a cellular telephone GPRS module 2, This module demands-high power ding predetermined periods. Supply 1 includes a battery module 3 for providing module 2 with a supply voltage that, in this embodiment, is about 3.6 Volts. During the predetermined periods, module 3 provides a first current at a first voltage that is less than the supply voltage. A supercapacitive device, in the form of a single supercapacitor 4, is connected in parallel with module 3 for providing module 2 with a second current during the predetermined periods such that first voltage is maintained above about 90% of the supply voltage. That is, the first voltage is maintained above about 3.24 Volts.

Module 2 is part of a handset 5 for a cellular telephone and includes many electronic circuits, both integrated and surface mounted, that perform the required functions. For the sake of clarity a subset of the circuits are shown schematically. More particularly, module 2 includes an intermediate frequency stage that is controlled by a digital signal processor 7 that is responsive to a data signal relayed on an input bus 8 for providing a modulation signal on an output bus 9. An RF oscillator 110 is included for providing a carrier signal on a line 11. Bus 9 and line 11 provide the modulations signal and the carrier signal to a mixer 12 which, in response, generates an SPSK signal complying with the GPRS standard and which is provided on line 13.

In other embodiments, module 2 is part of a wireless personal digital assistant (PDA) or other wireless device be that a laptop or other computer or a standalone communications handset. In further embodiments, module 2 conforms to a different wireless communication standard than GPRS. Examples of such standards include GSM, Mobitex, 3G and the like.

The 8PSK signal on line 13 forms the input for a power amplifier 14. This amplifier is responsive to the input for providing an output signal to drive an antenna 15. The output signal is at a power level set out in the standard, and is generally about 4 to 5 Watts.

The transmission of data in accordance with the GPES standard, as with most digital telecommunications standards, includes a series of transmission pulses of a defined duration that are separated by a defined period where no transmission occurs.

For the GPRS signals, the transmission pulses are of 0.577, 1.154 or 2.308 msec duration and the intermediate periods are of 4.039, 3.462 or 2.308 msec duration respectively. During the pulses and the intermediate periods the power consumption of the circuitry contained with handset 5 is respectively in a high power consumption mode and a low power consumption mode. The raised level of power consumption in the high power consumption mode is due predominantly to the pulsed operation of amplifier 14. However, it is also when the other circuitry is most nicely simultaneously active.

By way of example, a typical handset uses about 0.5 Watts during the low power consumption mode and about 4.5 Watts during the high power consumption mode. It will be appreciated that some variation occurs between handsets from different manufacturers.

Antenna 15 also receives incoming signals. White not illustrated in the drawings, these signals are passed to the input of an RF receive amplifier and amplified, and then passed to an input mixer for demodulation. Oscillator 10 or another similar oscillator provides Her 12 with the carrier signal to allow the demodulation to occur. Accordingly, as with the transmission of data, there is considerable activity and power consumption occurring. However, in the case the receiving data, the typical current drawn from module 3 is about 0.3 Amps as opposed to the 1 to 2 Amps required dung transmission.

When handset 5 is in a standby mode—that is, not in the transmitting or receiving mode—the power requirements are minimal. Typically, when in the standby mode, the handset would draw about 0.05 to 0.1 Amps.

Most digital circuits are designed for a constant voltage from a supply rail—be that ultimately supplied by a battery or other power source—and a varying supply current. However, due to the orders of magnitude difference between the “standby current” and the “high power consumption” current, it is difficult to strike the best compromise between low voltage ripple, and the cost of the circuitry to contain that voltage ripple. This is further compounded by the fact that the standby current is drawn most of the time, and the peak current—when the device is in the high power consumption mode—is only draw for short periods of time. It has been discovered by the inventors, however, that the inclusion of a supercapacitive device, and often a single supercapacitive device, in parallel with the load allows an amelioration of the disadvantages of the prior art.

In this embodiment handset 5 communicates wirelessly with a cellular base station 21 that is remote from the handset. In other embodiments, the handset communicates with other mobile devices instead of or in addition to station 21. It will also be appreciated that the communication between station 21 and handset 5 is two-way.

Station 21 is part of a larger cellular networks that includes a plurality of spaced apart like base stations (not shown) and a plurality of handsets that selectively communicate wirelessly with each other via the base stations.

Station 21 includes an antenna 22 for receiving the wireless signal provided by handset 5. This signal is passed to a power amplifier 23, and the amplified signal then provided on line 24 to a mixer 25. A local RF oscillator 26 generates a carrier signal at the frequency dictated by the standard—which corresponds to the frequency of the signal provided by oscillator 10—and supplies this to the mixer 25 via line 27. The resultant signal from mixer 25 is placed upon a bus 28 and passed to an IF receive stage including a digital signal processor 29. Processor 29 then uses this signal to reconstruct or represent the data originally provided on bus 8.

In this embodiment, module 3 is self-contained in a housing (not shown) that is separate from, but releaseably mechanically interconnectable with handset 5. The module 3 also includes terminals 35 for electrically engaging with complementary contacts 36 of module 2 when the housing is interconnected with handset 5.

In other embodiments, module 3 is integrated with the other circuitry contained within the handset housing.

Module 3 includes two lithium ion batteries 37 and 38 that are connected in parallel for providing the supply voltage of 3.6 Volts at terminals 35. In other embodiments only a single battery is used, while in further embodiments more than two batteries are used. While batteries are the preferred energy storage means for portable devices—primarily due to the high energy density—it will also be appreciated that in some embodiments module 3 includes energy storage means other than batteries. For example, means such as fuel cells, capacitors and other energy storage devices either alone or in combination.

Disposed between batteries 37 and 38 and terminals 35 is a protection circuit 39 for preventing undesirable current in the batteries. In this embodiment, circuit 39 caps the permissible current that is able to be drawn from the batteries. In other embodiments, circuit 39 also prevents the average current over of predetermined period from exceeding a predefined threshold. These steps are taken to minimise the risk of damage to the batteries in over-current conditions. In some cases, should such an over-current condition occur, circuit 39 shuts down the supply of curt from the batteries. However, in other embodiments, the current is simply limited.

Over the discharge cycle of batteries 37 and 38 the zero current or supply voltage will progressively reduce. For a typical lithium ion battery, the supply voltage will be about 4.2 Volts when the battery is fully charged, and about 2.9 Volts when the battery is substantively spent.

In the present embodiment, the supercapacitive device is chosen to ensure that during the reasonable operational discharge life of the battery that the first voltage is maintained at or above a predetermined percentage of the supply voltage. This also has the effect of reducing the variation in the first voltage that occurs during the high power mode.

Conversely, in other embodiments, the supercapacitive device is chosen to reduce the variation of the first voltage that occurs during the high power mode, again, during the reasonable operational discharge life of the battery. This also has the benefit of allowing the difference between the first voltage and the supply voltage to be more lightly contained.

Supercapacitor 4 includes approximate dimensions of about 29 mm×18 mm×3 mm, giving a total volume of about 1.5 cc. It also ha a capacitance of about 380 mF and an ESR of about 70 mΩ. The capacitance per unit volume of about 0.24 mF/mm³ is about two or three orders of magnitude greater than has been offered by tantalum capacitors.

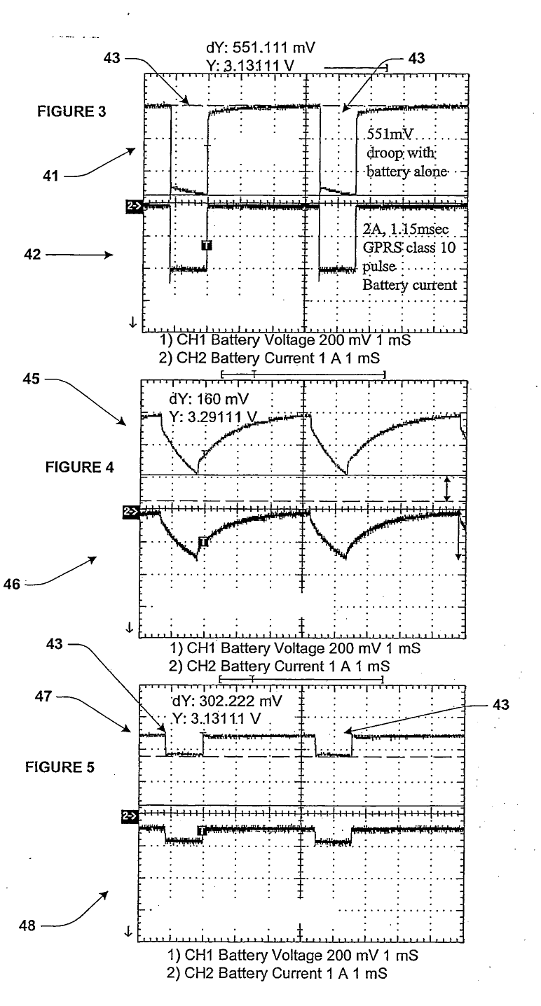

Reference is now made to FIGS. 3 to 5 that illustrate the improved performance offered by an embodiment of the invention. More particularly, FIG. 3 is a trace of the voltage and ent waveforms for module 3 that is supplying a GPRS module 2 that is operating in the high power consumption mode. In this embodiment, the battery module is comprised of a Li-Ion battery having a capacity of 600 mAmp hours and an internal resistance of about 250 mΩ. The top trace 41 in FIG. 3 represents the voltage at terminals 35, while the bottom trace 42 represents the current drawn from the batteries. It will be appreciated that for these results there is no supercapacitive device connected in parallel with terminals 35. That is, FIG. 3 represents one of the prior art arrangements.

In the high power consumption mode, as shown, the battery module 3 provides module 2 with a voltage of about 3.13 Volts as a load current is being drawn from the batteries. That is, the finite output impedance—the internal resistance—of the batteries 3 ensures that the supply voltage is less than the notional battery voltage. Moreover, dung this high power consumption period, there are defined intervals—designated by reference numeral 43—where amplifier 14 draws about 2 Amps. As intervals 43 commence, the battery voltage quickly falls by about 510 mV and then, throughout the interval, more gradually falls to about 551 mV less than the initial voltage. At the end of intervals 43 the battery voltage returns to the initial voltage, although there is some delay due to the time constant of the battery.

Corresponding traces 45 and 46 are provided in FIG. 4, although in this case, the battery module is connected in parallel with eight 470 μF tantalum capacitors. That is, a total capacitance of 3.76 mF is provided by these devices that have a a packaged volume of about 0.13 cc each, and a collective volume, allowing for space between them when mounted on a PCB, of about 1.5 cc. This equates to a capacitance per unit volume of about 0.0025 MF/mm³.

When use is made of the tantalum capacitors it is found, as shown in FIG. 4, that during corresponding intervals 43, the voltage provided at terminal 35 falls away quickly and then slightly less rapidly ramps down to 391 mV less than the initial voltage. At that point, amplifier 14 ceases drawing the transmission current and the batteries commence charging the capacitors. This charging only just occurs prior to the commencement of the next interval 43. The peak current drawn from the batteries falls from about 2 Amps, as is the case in FIG. 3, to about 1.5 Amps. The remainder of the current drawn by the communications module is sourced from the tantalum capacitors.

Accordingly, the use of eight tantalum capacitors maintains the minimum voltage supplied during intervals 43 at about 160 mV better than would occur if no assistance was provided to the battery. The small quantum of this benefit, when compared with the expense of the capacitors and the considerable space that they occupy, is generally sufficient to ensure that such capacitors are not used or only in those applications where expense or package are not the key design drivers.

It is evident from traces 45 and 46 that the tantalum capacitors have insufficient energy storage to fully assist the battery during intervals 43, not withstanding their considerable combined package volume. While that may be possible to overcome by placing more capacitors in parallel, the volume cost of providing that capacity is typically commercially unacceptable and, for some power supplies, simply not physically possible due to volume constraints with the associated electronic device, or footprint constraints on the relevant circuit board;

Corresponding traces 47 and 48 are provided in FIG. 5, although in this case, the battery module 3 is connected in parallel with supercapacitor 4. As is evident from the traces, although there is a small decrease in battery voltage at the start of intervals 43, there is no significant voltage decay during those intervals. This is because supercapacitor 4 has sufficient capacitance to store the energy required to deliver the peak load for the duration of the interval. The voltage drop during the load has been reduced by 302 mV from 551 mV for the battery alone, to 249 mV for the battery in parallel with the supercapacitor. Additionally, the change in voltage at terminal 35 during the high power consumption pulse train has been reduced from 551 mV to 140 mV

In the periods between intervals 43, the battery voltage is a little lower than is the case for the FIGS. 3 and 4 configurations. This is due to the charging current that is required for the supercapacitors. As batteries operate more effectively with more constant current drains, the use of the supercapacitor is advantageous.

Additionally, the ESR of the supercapacitor is low and, therefore, there will be very only low I²R losses in this passive component.

The use of supercapacitor 4 provides a significant improvement in the load regulation to module 2 in a cost effective and space effective manner. While improved load regulation is an advantage for most applications, in the present embodiment additional benefits arise. Particularly, when amplifier draws the peak current in intervals 43 and thereby drags the voltage at terminal 35 down, this also reduces the supply voltage available to other circuitry within module 3. Of these, it has been found by the inventors that the frequency of the carrier signal produced by oscillator 10 is very susceptible to variation in response to changes in the supply voltage. Similar comments apply to the output signal of mixer 12, although the effect is of a lesser magnitude.

The use a supercapacitor in parallel with the existing power supply rail—which in the above embodiments is provided by a battery module—maintains the rail so as to reduce the variation in frequency of the carrier signal in comparison to that provided by the prior art methodologies.

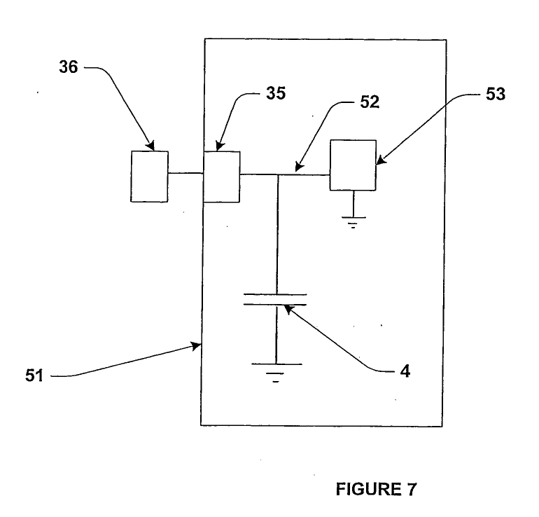

Any frequency variation in the carrier signal manifests as a phase error at the receiver end. For the SPSK modulation schema, which is represented in FIG. 6, there is indicated the effect of phase error at a receiver. As the phase error increases, the ability of the receiver to effectively reconstruct the original data is reduced mats is, phase errors due to poor supply rail regulation ultimately compromise the bit error rate of the transmission that is being made with module 2. Accordingly, as presently envisaged, the use of the preferred embodiments of the invention allows the bit error rates to be reduced over the operational life of the battery.

In other embodiments where a power source other than a battery module is used, the application of the invention is still advantageous as it allows the peak current drawn from the source to exceed, for at least short periods, the allowable peak current that that source—be it a regulator or otherwise—is able to reliably supply without compromising the supply voltage. This occurs in mains powered communications modules having internal regulators that are rated for a maximum current. On those occasions where a number of sub-circuits within the module simultaneously demand high currents, that can be sufficient to either trip the regulator into an oversupply condition, or alternatively, drop the supply voltage to a level below specification and compromise the functionality of the module, such as by degrading the bit error rate. It has been appreciated by the inventors that for communications modules the periods in which the peak current is above specification are often only short and well spaced wart in time.

As presently understood, the embodiment of FIG. 1 achieves the reduction in the error rate through one or more of the following:
1. By containing, dung intervals 43, the variation in the voltage provided by module 3 to less than a predetermined threshold of the zero current supply voltage of module 2. Preferably, that threshold is about 5% and more preferably about 3%.
2. By maintaining the voltage provided to module 2 at more than a predetermined threshold of the zero current supply voltage of module 2. Preferably, the threshold is about 90%, although more preferably about 92%, and most preferably about 95%.
3. By containing, during intervals 43, the variation in the voltage provided by module 3 to less than a predetermined threshold. Preferably, that threshold is about 200 mV.
4. By using a supercapacitor with an ESR that is less than the output impedance of the power source. In the case whore the power source is a battery, the ESR is less than the internal resistance of the battery.
5. By ensuring the supercapacitor provides sufficient energy storage so that the voltage decay during the peak load is less than or equal to the ESR drop of the supercapacitor. That is, that the voltage decay is less than the supercapacitor ESR×the peak load current
6. By providing a supercapacitor of low volume with respect to the available capacitance.
7. By providing a supercapacitor with a low ESIL More preferably, the ESR is less than 100 mΩ. More preferably, the ESR is less than 70 mΩ.

An alternative manner of expressing point 5 above is as follows. A power supply for a communications module that demands high power during predetermined periods is defined as including:

a battery module for providing the communications module with a supply voltage Vₛᵥ wherein, during the predetermined periods, the battery modules provides a first current i_{b} at a first voltage vₛ that is less than Vₛᵥ; and

a supercapacitive device having a predetermined equivalent series resistance R_{S} and being in parallel with the battery module, the supercapacitor providing the communications module with a second current is during the predetermined periods such that, throughout those periods, (Vₛᵥ−vₛ)≦R_{S}·(i_{b}+iₛ).

Preferably, the battery module consists of a battery. More preferably, the battery is a lithium ion battery and Vₛᵥ is about 3.6 V. Even more preferably, (Vₛᵥ−vₛ) is less than about 300 mV. However, in other preferred embodiments, (Vₛᵥ−vₛ) is less than about 250 mV.

An alternative embodiment of the invention, in the form of a power supply 51, is disclosed in FIG. 7 where corresponding features are denoted by corresponding reference numerals. In this embodiment, supply 51 includes, rather than a battery module, a supply rail 52 that emanates from a regulator 53. This regulator is mounted to a PCMCIA card for a laptop or a desktop computer (not shown).

Regulator 53 has a specified current capacity that is limited predominantly by the design parameters of the card itself. That is, while a mains supply is available, the regulator is only allocated a small proportion of the available real estate and can therefore only effectively regulate a certain threshold of average power consumption. As with module 2, the load of the regulator is pulsed between a low power consumption mode and a high power consumption mode to effect the desired wireless transmission. For prior-art power supply designs, the regulator typically has difficulty is adequately performing during the peak periods. In the FIG. 7 embodiment, however, the inclusion of supercapacitor 4 reduces the peak load on regular 53 such that it is able to operate within it design parameters.

The embodiments of the invention make use of low ESR and high capacitance per volume supercapacitors. This high volume efficiency ensures that effective package within the handset or other communications device is possible. This factor is paramount in the design and acceptance of portable devices. It also assists in the design of PC cards and other components including a communications module, as the increased space efficiency, and improvements to performance, allows more volume for other components.

FIG. 8 is a top view of a single cell supercapacitor 61 that is suitable for use in embodiments of the invention. The supercapacitor includes a generally rectangular top face 62 that is defined by four peripheral edges 63, 64, 65 and 66. The longer of the edges 63 and 65 define a longitudinal length “L₁” of supercapacitor 61 of about 39 mm, while the shorter of the edges 64 and 66 define a transverse width “W₁” of supercapacitor 61 of about 17 mm. In FIG. 8, L₁ and W₁ are illustrated by lines 67 and 68 respectively. Supercapacitor 61 also includes terminals 69 and 70 that extend longitudinally outwardly from respective edges 64 and 66 for allowing electrical connection of the supercapacitor to the surrounding circuitry. When the longitudinal extent of the terminals is taken into account, the longitudinal length “L₂” of supercapacitor 61 is about 42.5 mm. In FIG. 8, L₂ is illustrated by line 71.

Supercapacitor 61 includes bottom face (not shown) that is similar to face 62—in that it is of the same dimensions—but downwardly facing. This bottom face, in use, is closely adjacent to or resting against a circuit board (not shown) to which the supercapacitor is mounted. Additionally, in use, terminals 69 and 70 are soldered or otherwise electrically connected to respective contacts on the circuit board for affect the electrical connection with other components.

While supercapacitor 61 is shown with ideally normal intersections between adjacent edges 63 to 66, under normal manufacturing conditions there will inevitably arise some variation from this, including rounded corners, only substantially normal edges, and the like.

The product of L₁ and W₁ provide a quantification for the footprint of supercapacitor 61, which in turn is the minimum area required by the supercapacitor on the circuit board to which it is to be mounted and which must accommodate the normal manufacturing variations referred to above. Typically, such a footprint is defined by the designer of the board, and L₁ and W₁ are both set. In other embodiments more design flexibility is provided, in that the area is specified and L₁ and/or W₁ are determined by the manufacture of the supercapacitor.

Supercapacitor 61 includes a footprint of 39 mm×17 mm, or about 663 mm². However, some circuit board designers also include within the footprint the circuit board area taken by terminals 69 and 70. Where this is the case, supercapacitor 61 includes a footprint of 42.5 mm×17 mm, or about 722.5 mm². For convenience, the footprint of supercapacitor 61 excluding the terminals is referred to as “the footprint”, while the footprint of the supercapacitor including the terminal is referred to as “the total footprint”.

Supercapacitor 61 has a height “H” (not shown) that is the maximum height of the supercapacitor as measured normal to face 62. In practice, the height is measured normal to the circuit board to which supercapacitor 61 is to be mounted. The volume of the supercapacitor in packing terms is the product of the footprint (or the total footprint) and the height, notwithstanding that this may be slightly greater than the actual volume displaced by the supercapacitor.

Table 1 includes a number of examples of supercapacitive devices, in the form of carbon double layer supercapacitors, that are suitable for use with embodiments of the invention. The single cell supercapacitors include “1” as the first numeral in their respective model designation and have an operational voltage of 2.25 Volts. This model designation is that which is applied to the devices by the corporate applicant of the present application.

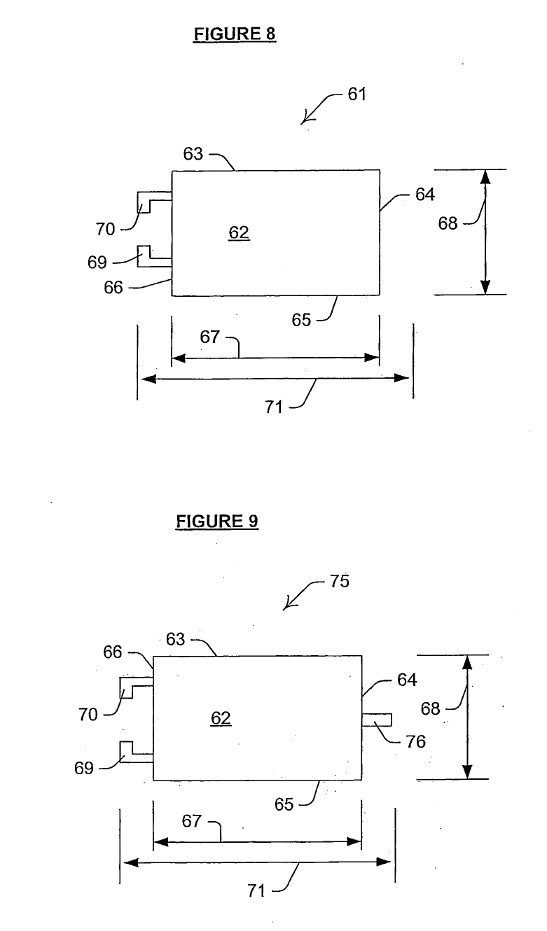

FIG. 9 is a top view of a multicell supercapacitor in the form of a supercapacitor 75 that has two cells (not shown), and where corresponding features are denoted by corresponding reference numerals. Terminals 69 and 70 of supercapacitor 75 both extend longitudinally from edge 66, while a third terminal 76 extends longitudinally in the opposite direction from edge 64. Terminal 76 provides terminal electrical access to the connection between the two cells primarily for allowing balancing of the voltages across those cells. L₁, L₂ and W₁ for supercapacitor 75 are 28.5 mm, 32.5 mm and 17 mm respectively.

Table 1 includes a number of examples of supercapacitive devices, in the form of carbon double layer supercapacitors, which are suitable for use with embodiments of the Invention. The model number is that allocated to the devices by the corporate applicant of the present application. The multi-cell supercapacitors include “2” as the fist digit in their respective model designation and have an operational voltage of 4.5 Volts.

TABLE 1

| | Voltage | L₁ | W₁ | | Footprint | Cap | Volume | ESR |
|---|---|---|---|---|---|---|---|---|
| Model | (V) | (mm) | (mm) | H (mm) | (L₁ × W₁) | (mF) | (L₁ × W₁ × H) | (mΩ) |
| GS108A | 2.25 | 39 | 17 | 2.46 | 663 | 2700 | 1630 | 10 |
| GS105A | 2.25 | 39 | 17 | 1.91 | 663 | 950 | 1266 | 12 |
| GS107A | 2.25 | 39 | 17 | 1.8 | 663 | 1900 | 1193 | 14 |
| GS110A | 2.25 | 39 | 17 | 2.5 | 663 | 4900 | 1657 | 16 |
| GS111A | 2.25 | 39 | 17 | 1.36 | 663 | 650 | 901 | 18 |
| GS104A | 2.25 | 39 | 17 | 1.18 | 663 | 550 | 782 | 22 |
| GS103A | 2.25 | 39 | 17 | 0.99 | 663 | 400 | 656 | 26 |
| GS106A | 2.25 | 39 | 17 | 1.14 | 663 | 1100 | 755 | 26 |
| GS101A | 2.25 | 39 | 17 | 1.54 | 663 | 2800 | 1021 | 28 |
| GS102A | 2.25 | 39 | 17 | 0.81 | 663 | 300 | 537 | 34 |
| GS112A | 2.25 | 39 | 17 | 0.74 | 663 | 200 | 490 | 50 |
| GW110A | 2.25 | 28.5 | 17 | 2.28 | 484.5 | 650 | 1104 | 16 |
| GW111A | 2.25 | 28.5 | 17 | 2.46 | 484.5 | 1600 | 1191 | 18 |
| GW108A | 2.25 | 28.5 | 17 | 1.91 | 484.5 | 550 | 925 | 20 |
| GW113A | 2.25 | 28.5 | 17 | 2.5 | 484.5 | 2800 | 1211 | 28 |
| GW103A | 2.25 | 28.5 | 17 | 1.58 | 484.5 | 950 | 765 | 30 |
| GW102A | 2.25 | 28.5 | 17 | 1.36 | 484.5 | 350 | 658 | 30 |
| GW107A | 2.25 | 28.5 | 17 | 1.36 | 484.5 | 800 | 658 | 34 |
| GW101A | 2.25 | 28.5 | 17 | 1.14 | 484.5 | 650 | 552 | 40 |
| GW109A | 2.25 | 28.5 | 17 | 0.99 | 484.5 | 250 | 479 | 45 |
| GW104A | 2.25 | 28.5 | 17 | 1.54 | 484.5 | 1600 | 746 | 45 |
| GW105A | 2.25 | 28.5 | 17 | 0.92 | 484.5 | 500 | 445 | 55 |
| GW114A | 2.25 | 28.5 | 17 | 0.81 | 484.5 | 180 | 392 | 60 |
| GS208D | 4.5 | 39 | 17 | 4.99 | 663 | 1400 | 3308 | 20 |
| GS205D | 4.5 | 39 | 17 | 3.9 | 663 | 450 | 2585 | 24 |
| GS207D | 4.5 | 39 | 17 | 3.67 | 663 | 950 | 2433 | 28 |
| GS210D | 4.5 | 39 | 17 | 5.07 | 663 | 2400 | 3361 | 32 |
| GS211D | 4.5 | 39 | 17 | 2.79 | 663 | 300 | 1849 | 34 |
| GS204D | 4.5 | 39 | 17 | 2.43 | 663 | 250 | 1611 | 40 |
| GS203D | 4.5 | 39 | 17 | 2.06 | 663 | 200 | 1365 | 50 |
| GS206D | 4.5 | 39 | 17 | 2.35 | 663 | 550 | 1558 | 50 |
| GS201D | 4.5 | 39 | 17 | 3.15 | 663 | 1400 | 2088 | 55 |
| GS202D | 4.5 | 39 | 17 | 1.69 | 663 | 160 | 1120 | 70 |
| GS212D | 4.5 | 39 | 17 | 1.55 | 663 | 100 | 1027 | 100 |
| GW210D | 4.5 | 28.5 | 17 | 4.63 | 484.5 | 350 | 2243 | 32 |
| GW211D | 4.5 | 28.5 | 17 | 4.99 | 484.5 | 800 | 2417 | 34 |
| GW208D | 4.5 | 28.5 | 17 | 3.9 | 484.5 | 300 | 1889 | 40 |
| GW213D | 4.5 | 28.5 | 17 | 5.07 | 484.5 | 1400 | 2456 | 55 |
| GW203D | 4.5 | 28.5 | 17 | 3.23 | 484.5 | 500 | 1564 | 55 |
| GW202D | 4.5 | 28.5 | 17 | 2.79 | 484.5 | 180 | 1351 | 60 |
| GW207D | 4.5 | 28.5 | 17 | 2.79 | 484.5 | 400 | 1351 | 65 |
| GW201D | 4.5 | 28.5 | 17 | 2.35 | 484.5 | 300 | 1138 | 85 |
| GW209D | 4.5 | 28.5 | 17 | 2.06 | 484.5 | 120 | 998 | 90 |
| GW204D | 4.5 | 28.5 | 17 | 3.15 | 484.5 | 800 | 1526 | 95 |
| GW205D | 4.5 | 28.5 | 17 | 1.91 | 484.5 | 250 | 925 | 110 |
| GW214D | 4.5 | 28.5 | 17 | 1.69 | 484.5 | 90 | 818 | 115 |
| In the above table, the second column refers to the operational voltage of the respective supercapacitors, while the third, fourth and fifth columns respectively refer to values of L₁, W₁ and H, which are expressed in millimetres. The sixth column is a simple product of L₁ and W₁ to provide the footprint in mm². If the total footprint is required, use is made of L₂ rather than L₁. The seventh column provides the | | | | | | | | |
| # packaging volume of the supercapacitors, while the eighth column includes the ESR for the supercapacitors. The values provided are nominal and will across like devices vary due to normal manufacturing tolerances. | | | | | | | | |

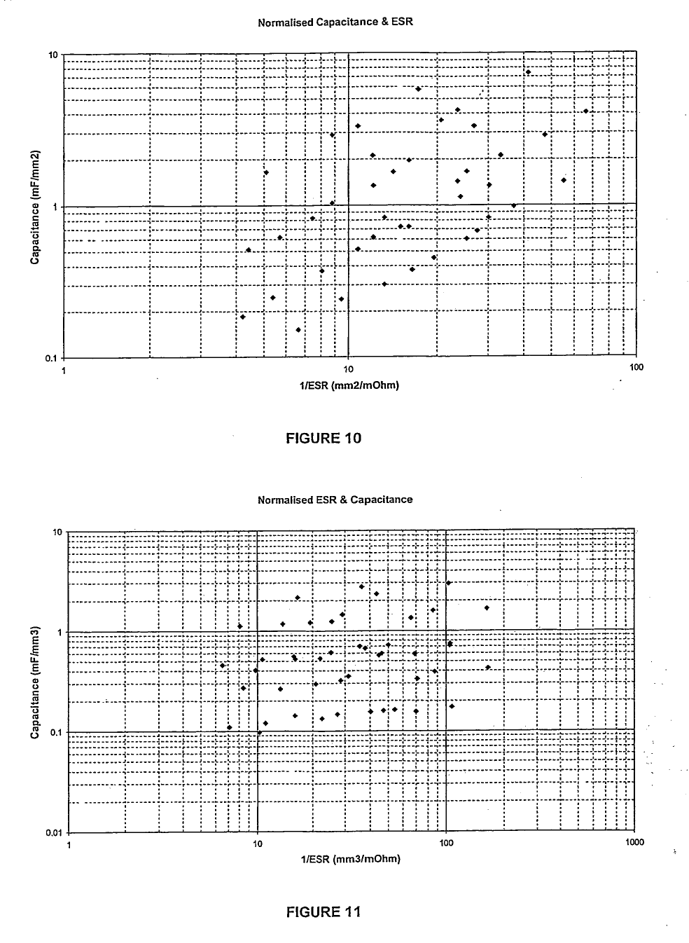

These supercapacitors are suited to embodiments of the invention as they achieve a relatively high capacitance and low ESR for a given footprint and for a given package volume. By way of example, reference is made to FIG. 10 that provides for the supercapacitors listed in the above table a plot of the capacitance against the reciprocal of the respective FSR when both are normalised for the footprint. That is, the x-axis is the footprint/ESR (referred to as E_{fp}) and is expressed in mm²/ml, while the y-axis is the capacitance/footprint (referred to as C_{fp}) and is expressed in mFarads/mm². For the above supercapacitors (E_{fp}+C_{fp})^{0.5} is greater than about 4. Preferably, however, (E_{fp}+C_{fp})^{0.5} is greater than about 5. As will be noted from FIG. 9, some of the supercapacitors provide (E_{fp}+C_{fp})^{0.5} that is greater than about 10, while in other cases (E_{fp}+C_{fp})^{0.5} is greater than about 66.

Where use is made of the total footprint as opposed to the footprint, the above figures are recalculated accordingly.

It will be appreciated by those skilled in the art that in the design of some embodiments of the invention, the ESR is a more critical design requirement, while in the design of other embodiments of the invention the capacitance is the more critical design requirement. This is dependent upon a number of factors including the output impedance of die battery or other power source being used, the input impedance of the load, and the load pulse characteristics.

It has been found by the inventors that where the ESR is the more critical design requirement for an embodiment, this requirement is best met by selecting E_{fp} to be greater than about 4 mm²/mΩ, and more preferably, greater than about 5 mm²/mΩ. In some embodiments, E_{fp} is greater than about 10 mm²/mΩ, while in others it is greater than 66 mm²/mΩ.

It has been found by the inventors that where the capacitance is the more critical design requirement for an embodiment, this requirement is best met by selecting C_{fp} to be greater than about 0.15 mF/mm², and more preferably, greater than about 0.5 mF/mm². In some embodiments, C_{fp} is greater than about 1 mF/mm².

For some embodiments of the invention there are not only tight constraints upon the footprint, but also on the height of the supercapacitor. For example for those embodiments for use in PCMCIA cards, the height of the card itself is only about 5 mm which, when other components are accommodated, leaves less than about 2.3 mm of headroom for a supercapacitor. For the current and voltage loads experienced, there is a need to provide a relatively high capacitance and a relatively low ESR for the given volume. Tis is able to be achieved by the embodiments of the invention through selecting a supercapacitor having characteristics such as those found in the supercapacitors from the above table.

FIG. 11 provides for all the supercapacitors in Table 1 a plot of the capacitance per unit volume (referred to as Cᵥₒₗ) expressed in mF/mm³ against the reciprocal of ESR per unit volume (referred to as Eᵥₒₗ) expressed in mm³/mΩ. While all the supercapacitors have provide an Eᵥₒₗ of greater than 6 mm³/mΩ, others provide an Eᵥₒₗ of greater than about 20 mm³/mΩ, while others provide an Eᵥₒₗ of greater than about 100 mm³/mΩ. For Cᵥₒₗ all the supercapacitors provide at least 0.09 mF/mm³, while some provide greater than about 0.5 mF/mm³. For others of the supercapacitors, Cᵥₒₗ is greater than about 2 mF/mm³.

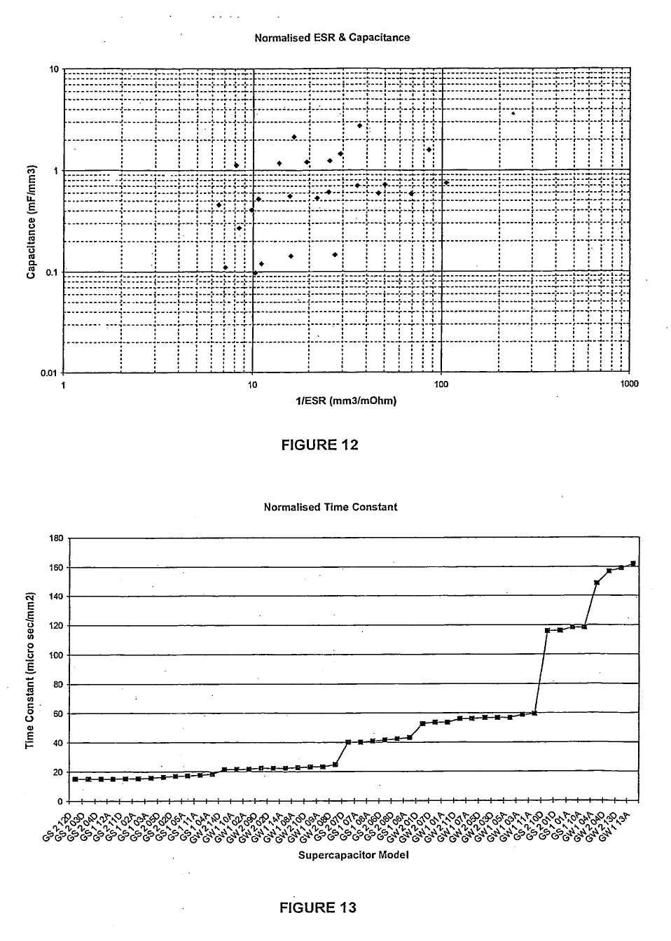

FIG. 12 is similar to FIG. 11 and illustrates the corresponding data for only those supercapacitors in Table 1 having a thickness of less than 2.3 mm, These devices are particularly suitable for use in a PCMCIA card and, depending upon the characteristics of the load, are typically able to perform in accordance with one or more aspects of the invention. That is, to contain the current provided by the power supply within its maximum allowable limit, while allowing the load (the PCMCIA card or a component within that card such as a GSM communication module) to periodically, intermittently or otherwise draw a short duration maximum current that is greater than the maximum allowable limit.

Reference is now made to Fire 13 where there is illustrated for the supercapacitors of Table 1 a plot of their respective RC time constants when normalised for footprint (referred to as T_{fp}) and which is expressed in μsec/mm². For the loads being contemplated with the invention, it is found that use is best made of supercapacitive devices having a T_{fp} of greater than about 15 μsec/mm². In some embodiments T_{fp} is greater than 40 μsec/mm². In still further embodiments, Trp is greater than about 120 μsec/mm².

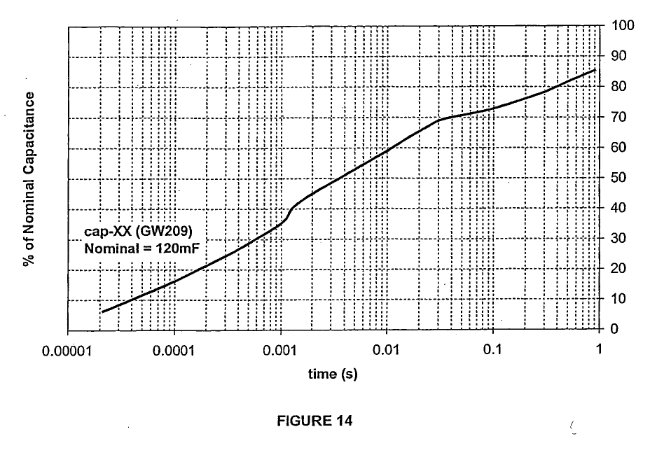

Reference is now made to FIG. 14 where there is shown a plot of the effective capacitance (C_{eff}) of a supercapacitive device for a given pulse width. During that pulse a communication module demands a substantially constant current from a power supply including the supercapacitive device. C_{eff} is expressed as a percentage of the normal DC capacitance for the supercapacitive device. In this particular example the supercapacative device is a supercapacitor from Table 1 having the model designation GW209D and which has a nominal DC capacitance of 120 mF. It should be noted that as the pulse width narrows, C_{eff} falls. Taking the example of a GPRS signal, the period that the supercapacitor supplies current to the load is during the transmission pulses, which are of 0.577, 1.154 or 2.308 msec duration. The defining period for C_{eff} is during the transmission pulses. For the example provided in FIG. 14, for those given pulse widths, C_{eff} is still greater than about 30%. Similar results are obtained or other of the supercapacitors from Table 1. Accordingly, it has been found that the supercapacitors provide:
A high capacitance per unit volume
A high capacitance per unit footprint.
A high effective capacitance for pulse widths commonly used in communications modules.
A low ESR per unit footprint.
A low ESR per unit volume.
A high time constant per unit footprint.

The combination of high capacitance per unit volume or per unit footprint is particularly advantageous in combination with a high effective capacitance for the pulse widths experienced by the supercapacitor.

The supercapacitors listed in Table 1 are all carbon double layer supercapacitors that are made in accordance with the methodologies disclosed in PCT patent application no. PCT/AU01/01613, the content of which is incorporated herein by way of cross-reference. The supercapacitors include one or more pairs of carbon coated aluminium sheet electrodes' that are stacked within a sealed package. It has been appreciated by the inventors that, where possible, use is made of as many pairs of coated electrodes as possible given the design constraints for the height of the supercapacitor. As will be understood from the above referred to patent application, alternate electrodes in the stack are electrically connected to each other and then to respective terminals that extend from the package. The use of a greater number of pairs of electrodes in the present embodiments has the effect of maximising the capacitance and minimising the ESR for the given footprint and volume.

The supercapacitors referred to in Table 1 all have at least one pair of electrodes with their respective housing. The common number of pairs, however, is between 3 and 6. In other embodiments and particularly where height requirements allow, use is made of supercapacitive devices with greater than six pairs of electrodes.

PCT patent application no. PCT/AU99/01081, the disclosure of which is incorporated herein by way of cross-reference, teaches that gravimetric and volumetric FOM's for supercapacitors are improved through the use of coatings including carbon particles having a diameter in the same order as the thickness of the coating. It has been appreciated by the inventors that thin coatings contribute to the performance benefits of the embodiments of the invention disclosed in this present application. That is, the thin coatings provide:
Room for one or more additional electrode pairs within a given package height.
A reduced ESR in absolute and volumetric terms.
An improved DC capacitance
An improved pulse response.

The embodiments of the invention make use of coatings on the electrodes of less than 50 microns thickness, and preferably less than about 36 microns thickness. For those embodiments relating to GPRS signals, use is made of coatings on the electrode of less than about 14 microns in thickness. However, for some embodiments, use is made of coatings of less than about 6 microns in thickness.

Better load regulation, such as that provided by the embodiments of the inventions provides many advantages, including increased run'times, lower bit error rates, lower phase errors and the like. In particular, FIG. 1 shows comparison of received and transmitted data to determine a Bit Error Rate (BER). The improved load regulation improves the performance of the oscillator and modulation circuits, thereby reducing the phase error, and thereby reducing the BBER This enables longer battery run times—that is, increased discharge of the battery—before phase errors in module 2 become out of specification.

It will be appreciated by a skilled addressee, from the teaching herein, that in other embodiments supply 51 is associated with a wireless communications card that is disposed within a computer and which allows that computer to communicate with a wireless LAN. The computer is, in some embodiments, as desktop computer, although in other embodiments use is made of laptop or other computers.

Although the invention has been described with reference to specific examples it will be appreciated by those skilled in the art that it may be embodied in many other forms.

1. A power supply including:
a supply rail that provides a supply current of up to a predetermined current limit to a load that draws a load current; and
a supercapacitive device connected in parallel with the supply rail or the load for allowing the load current to temporarily exceed the predetermined current limit while maintaining the supply current at less than the predetermined current limit.

2. A supply according to claim 1 wherein the supercapacitive device has an effective capacitance of at least 10% for a 0.03 msec pulse.

3. A supply according to claim 1 wherein the supercapacitive device has an effective capacitance of at least 35% for a 1 msec pulse.

4. A supply according to claim 1 wherein the supercapacitive device has an effective capacitance of at least 55% for a 10 msec pulse.

5. A power supply for a load, the power supply including:
a voltage rail for providing a voltage to the load;
a supercapacitive device having a predetermined footprint and a predetermined ESR for connecting to the rail in parallel with the load, wherein the quotient of the predetermined footprint and the predetermined ESR is greater than about 4 mm²/mΩ.

6. A supply according to claim 5 wherein the quotient is greater than about 5 mm²/mΩ.

7. A supply according to claim 5 wherein the quotient is greater than about 10 mm²/mΩ.

8. A supply according to claim 1 wherein the quotient is greater than about 66 mm²/mΩ.

9. A power supply for a load, the power supply including:
a voltage rail for providing a voltage to the load;
a supercapacitive device having a predetermined volume and a predetermined ESR for connecting to the rail in parallel with the load, wherein the quotient of the predetermined volume and the predetermined ESR is greater than about 6 mm³/mΩ.

10. A supply according to claim 9 wherein the quotient is greater than about 20 mm³/mΩ.

11. A supply according to claim 10 wherein the quotient is greater than about 100 mm³/mΩ.

12. A supply according to claim 9 wherein the supercapacitor has a height that is less than 2.3 mm.

13. A supply according to claim 9 wherein the voltage rail is supplied by a battery source.

14. A supply according to claim 9 wherein the voltage rail is supplied by a regulated power supply.
